(19) United States
(12) Patent Application Publication
(10) Pub. No.: US 2004/0036685 A1
(43) Pub. Date: Feb. 26, 2004

(54) Driving apparatus of plasma display panel and fabrication method thereof

(75) Inventors: Jin Hyung Ryu, Boochun-si (KR); Bong Joo Baik, Yongin-si (KR); Sam Je Cho, Anyang-si (KR); Woo Sung Jang, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/645,800

(22) Filed: Aug. 22, 2003

(30) Foreign Application Priority Data
Aug. 23, 2002 (KR) 2002/50166

(51) Int. Cl. G09G 5/00

(52) U.S. Cl. 345/204

(57) ABSTRACT

Disclosed are a driving apparatus of a PDP to decrease the size of the PDP as well as to enhance electrical characteristics by mounting a plurality of control chips and memories on a single package, and a fabrication method thereof. The driving apparatus includes a multi-chip module in which at least one control chip having a control circuit for controlling the PDP, and at least one memory are mounted on a single package, wherein the multi-chip module is mounted on a printed circuit board (PCB) of a control board.

### BACKGROUND OF THE INVENITON

1. Field of the Invention

The present invention relates to a plasma display panel (PDP), and more particularly, to a driving apparatus of a PDP to decrease the size of the PDP as well as to enhance electrical characteristics, and a fabrication method thereof.

2. Description of the Related Art

Plasma display panel (hereinafter referred to as “PDP”) generally displays an image including character or graphic by illuminating fluorescent substance using ultraviolet rays with a wavelength of 147 nm, which is generated during a gas discharge of He+Xe, Ne+Xe, He+Ne+Xe. This PDP is highlighted as the large-sized flat panel display owing to its easy slimness and large-sized characteristics, and is widening market share since the commercial production of providers.

Keeping in pace with the miniaturization of various electronic devices, the PDP is being fabricated in a compact type. This also results in a high integration of the driving circuit for controlling the PDP. Accordingly, the driving apparatus on which the driving circuit is mounted is also made in a compact type.

FIG. 1 is a view schematically showing a driving apparatus of a general PDP, FIG. 2 is a detailed view of the driving part of the driving apparatus of the PDP of FIG. 1, and FIG. 3 is a detailed view of the control board in the driving apparatus of the PDP of FIG. 1.

Referring to FIGS. 1 to 3, the driving apparatus of a general PDP includes an interface board 11 for receiving a TV/PC video signal and a synchronous signal, an AC-DC converter 12 for converting an AC signal into a DC signal, and a PDP module 15 for controlling a PDP as a whole, based on the video signal and the synchronous signal.

The interface board 11 converts the video signal into a digital data signal and supplies the converted digital data signal to the PDP module 15. Also, the interface board 11 supplies an ON Screen Display (OSD) signal generated from an OSD generating circuit (not shown), and a remote control signal inputted from a remote controller (not shown), to the PDP module 15.

The PDP module 15 includes a PDP 16 provided with an upper block 22A and a lower block 22B on which driving electrodes (YU1 to YUn, YD1 to YDn, ZU1 to ZUn, XU1 to XUm, XD1 to XDm) are arranged, address driving parts 18A, 18B for supplying data signals to address electrodes of the PDP (XU1 to XUm, XD1 to XDm), a scan driving part 17 for supplying a scan signal and a sustain signal to scan electrodes (YU1 to YUn, YD1 to YDn), a sustain driving part 19 operating alternatively with the scan driving part 17 and for supplying a sustain signal to sustain electrodes (ZU1 to ZUn) of the PDP 16, a control board 13 connected between the interface board 11 and the respective electrode driving parts 17 to 19 of the PDP 16, and a DC-DC converter 14 connected with the AC-DC converter 12.

The PDP 16, as shown in FIG. 2, includes scan electrodes (YU1 to YUn, YD1 to YDn) and sustain electrodes (ZU1 to ZUn) arranged respectively on the upper block 22A and the lower block 22B, and address electrodes (XU1 to XUm, XD1 to XDm) arranged respectively on the upper block 22A and the lower block 22B and crossed with the electrodes (YU1 to YUn, YD1 to YDn, ZU1 to ZUn, ZD1 to ZDn).

The scan driving part 17 is connected with the scan electrodes (YU1 to YUn, YD1 to YDn) to concurrently supply a reset signal to the scan electrodes (YU1 to YUn, YD1 to YDn) for a reset period, and also to sequentially supply a scan pulse to the scan electrodes (YU1 to YUn, YD1 to YDn) for a scan period. Also, the scan driving part 17 concurrently supplies a sustain pulse to the scan electrodes (YU1 to YUn, YD1 to YDn) for a sustain period.

The sustain driving part 19 is connected commonly with the sustain electrodes (ZU1 to ZUn) of the upper block 22A and the lower block 22B, and operates alternatively with the scan driving part 17 for the sustain period to concurrently supply the sustain pulse to the sustain electrodes (ZU1 to ZUn).

The first address driving part 18A supplies data signal to the address electrodes (XU1 to XUm) arranged on the upper block 22A for the address period. The second address driving part 18B operates concurrently with the first address driving part 18A to supply data signal to the address electrodes (XD1 to XDm) arranged on the lower block 22B.

As shown in FIG. 3, the control board 13 includes a digital data receiving part 31 for receiving the digital data signal (RGB) converted in the interface board 11 and the synchronous signal (V, H), a timing controller 32 and a digital video controller 37 connected with the digital data receiving part 31, and a first buffer 34, a second buffer 35 and a third buffer 36 connected with the timing controller 32.

The digital receiving part 31 aligns the digital video data signal (RGB) by color signal of R, G, B, by frame, and by bit to supply the aligned digital video data signal to the digital video controller 37, and also supplies gamma-corrected digital video data signal (RGB) received from the digital video controller 37 and the synchronous signal (V, H) received from the interface board 11 to the timing controller 32.

The digital video controller 37 gamma-corrects the data signal supplied from the digital data receiving part 31 and also sets sustain pulse number according to a preset average picture level (APL) to supply the gamma-corrected digital video data signal and the sustain pulse number information to the digital data receiving part 31.

The timing controller 32 divides the gamma-corrected digital video data signal (RGB) received from the digital data receiving part 31 by color signal, by frame and by bit, stores the divided signals in a frame memory 33, synchronizes each sub-field according to the synchronous signal to read out a bit data signal mapped in a corresponding sub-field from the memory 33 and supplies the read bit data signal to the first buffer 34. For this purpose, the timing controller 32 is provided therein with a plurality of system control chips 26 implemented in an ASIC (Application Specific Integrated Circuit) type, and a plurality of memories 33 for separating and storing digital video data signal by color signal, by frame and by bit.

At this time, the frame memories 33 are implemented by SRAM, DRAM or the like. In addition, the system control chip 26 is generally formed by a ball grid array (BGA) package.

The first buffer 34 divides the data signal received from the timing controller 32 into first and second data signals respectively to supply the divided first and second data signals to the second buffer 35 and the third buffer 36.

The second buffer 35 is connected between the first buffer 34 and the first address driving part 18A to buffer the first data signal received from the first buffer 34 and supply the buffered first data signal to the first address driving part 18A.

The third buffer 36 is connected between the first buffer 34 and the second address driving part 18B.

FIG. 4 is a block diagram showing a rear arrangement of the driving apparatus of the PDP of FIG. 1.

Referring to FIG. 4, since the plurality of system control chips 26 of the timing controller 32 mounted on the control board 13 is in charge of input and output functions of various driving signals, it needs approximately 300 or more input/output (I/O) signal lines.

Also, the plurality of system control chips 26 use one or more BGA package depending on the resolution and function of the PDP. At this time, since the I/O signal lines connecting between the BGA packages are arranged throughout a considerably large region, the line area occupied by the signal lines is too large.

In addition, since most of the plurality of frame memories 33 are connected by the I/O signal lines of the BGA package used in the ASIC part, the memories are generally fabricated in a TSOP (Thin Small Outline Package) type.

Then, the BGA packages and the TSOP used for the system control chips 26 and the frame memories 33 have a size that is several times larger than the bare chip of the ASIC or the bare chip of the memory. Thus, the system control chip packages of the timing controller 32 and the frame memory packages mounted on a PCB (printed circuit board) of the control board 13 occupies a large area on the PCB.

Further, there is needed: a large area for many signal lines on the PCB of the control board 13 so as to connect the I/O signal lines of the system control chip packages and the I/O signal lines of the frame memory packages with each other. The many signal lines formed on the large area increase an overall length of the signal lines by the area of the signal lines, resulting in an increase of inductance. In other words, since each of the plurality of frame memories 33 located around the system control chips (ex. ASIC) is mounted on the PCB of the control board 13 in the form of an individual package, the frame memories 33 occupy a large area.

Furthermore, since the respective frame memories are individually mounted, the length of the signal lines for connecting the respective frame memories is lengthened and accordingly, the signal lines are formed close as well. As a result, inductance formed between the adjacent signal lines is increased and thus the signal property of the frame memory is deteriorated. In other words, the control board 13 of the PDP according to the conventional art has a disadvantage in that the signal property is deteriorated due to the inductance increase between the signal lines connecting between the system control chips 26 and the frame memories 33.

Moreover, the driving module of the conventional PDP is fabricated in a considerably large size due to the frame memories 33 formed around the system control chips 26, which causes a drawback incapable of decreasing the size of the driving system of the PDP and of keeping in pace with the recently requested compactness of the PDPs.

### SUMMARY OF THE INVENTION

Accordingly, the present invention is directed to a driving apparatus of a PDP and a fabrication method thereof that substantially obviate one or more problems due to limitations and disadvantages of the related art.

It is an object of the present invention to provide a driving apparatus of a PDP to decrease the size of the PDP as well as to enhance electrical characteristics by mounting a plurality of control chips and memories on a single package, and a fabrication method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a driving apparatus of a PDP. The driving apparatus includes a multi-chip module in which at least one control chip having a control circuit for controlling the PDP, and at least one memory are mounted on a single package, wherein the multi-chip module is mounted on a printed circuit board (PCB) of a control board. The package is preferably formed in a ball grid type.

In an aspect of the invention, there is a driving apparatus of a PDP. The driving apparatus includes: a control board provided with a multi-chip module in which at least one control chip having a control circuit for controlling the PDP, and at least one memory are mounted on a single package; a plurality of driving units for generating and applying a driving signal corresponding to a control signal generated from the control board; and a PDP for displaying an image by a plasma discharge according to the driving signal applied from each of the plurality of driving units.

The control board can be provided with a printed circuit board (PCB) on which at least one package is mounted.

The multi-chip module can be mounted on the PCB.

In another aspect of the invention, there is provided a method for fabricating a driving apparatus of a plasma display panel. The method includes the steps of: forming holes and circuit patterns in and on a plurality of substrates; laminating the plurality of substrates to form a single package such that the circuit patterns formed on the respective substrates are electrically connected with each other through the holes; mounting at least one control chip and at least one memory on the package; and coating a coating material on a front surface of the package and attaching solder balls on a rear surface of the package to complete a multi-chip module.

When the plurality of substrates are laminated, the circuit patterns are electrically connected by the holes filled with the conductive material.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a general driving apparatus of a plasma display panel;

FIG. 2 is a detailed view of a driving unit in the driving apparatus of the plasma display panel of FIG. 1;

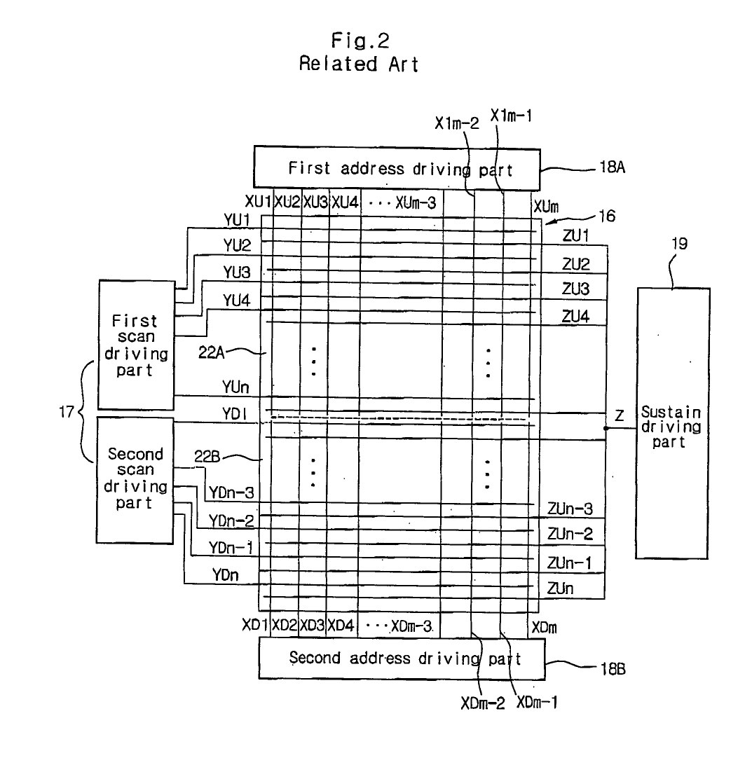

FIG. 3 is a detailed view of a control board in the driving apparatus of the plasma display panel of FIG. 1;

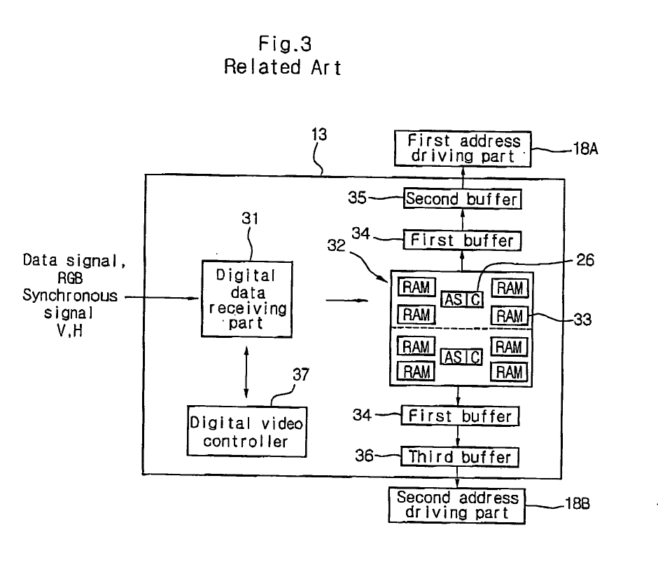

FIG. 4 illustrates a real arrangement of the driving apparatus of the plasma display panel of FIG. 1;

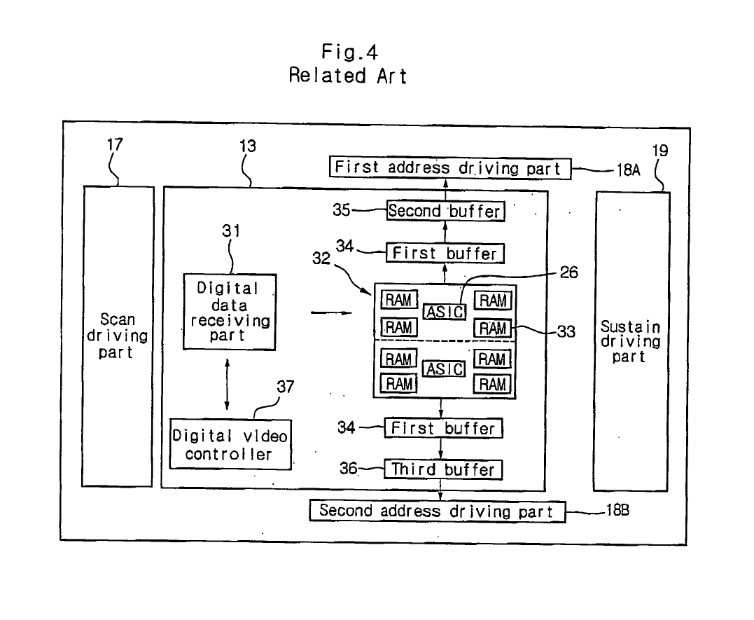

FIG. 5 is a detailed view of a control board in a driving apparatus of a plasma display panel according to a preferred embodiment of the present invention;

FIG. 6 is a view in which the control board of FIG. 5 is applied to a driving apparatus of a plasma display panel;

FIG. 7 illustrates a fabrication process of a multi-chip module package mounted on the control board of PIG. 5;

FIG. 8 shows the front and rear sides of the multi-chip module package fabricated by the process of FIG. 7; and

FIGS. 9A and 9B show an inventive control board and a conventional control board respectively.

### DETAILED DESCRIPTION OF THE INVENTION

Reference will now be made in detail to the preferred embodiments of the present invention, examples of which are illustrated in the accompanying drawings.

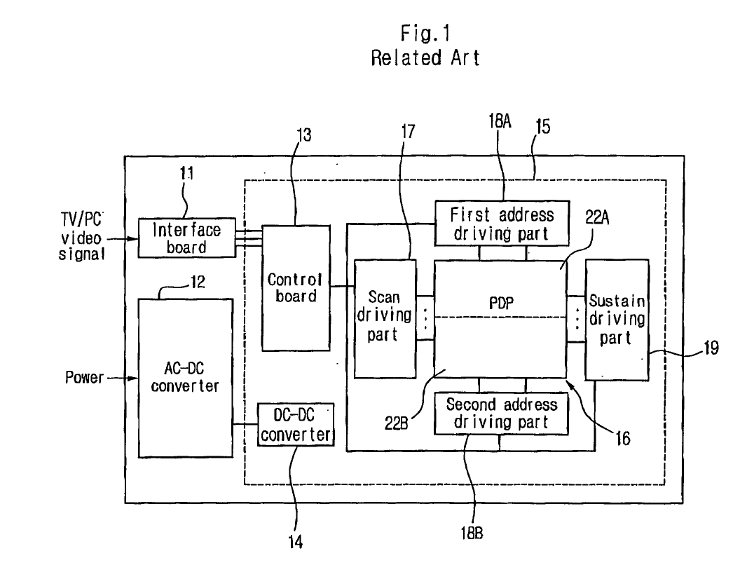

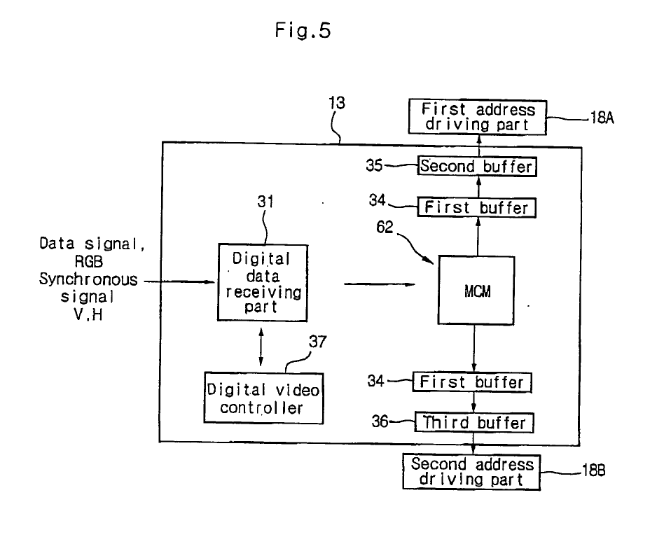

FIG. 5 is a detailed view of a control board in a driving apparatus of a plasma display panel according to a preferred embodiment of the present invention. The driving apparatus of the plasma display panel according to the present invention is similar to that of FIG. 1. However, it is noted that the invention is characterized by a multi-chip module (hereinafter referred to as “MCM”) for performing the function of the conventional timing controller, and a fabrication method of such a multi-chip module package. Hereinafter, wherever possible, the same reference numbers will be used throughout the drawings to refer to the same or like parts.

Referring to FIG. 5, the control board 13 includes a digital data receiving part 31 for receiving a digital video data signal (RGB) and a synchronous signal (V, H), a multi-chip module (MCM) 62 connected with the digital data receiving part 31 and a digital video controller 37, and a first buffer 34, a second buffer 35 and a third buffer 36 connected with the MCM 62.

Digital data receiving part 31 aligns digital video data signal by color signals of R, G and B, by frame, and by bit to supply the aligned digital video data signals to the digital video controller 37, and supplies gamma-corrected digital video signals (RGB) and the synchronous signals (V, H) inputted from the interface board 11 (see FIG. 1) to the MCM 62.

Digital video controller 37 gamma-corrects data signals received from the digital data receiving part 31 and sets sustain pulse number according to a preset average picture level (APL) to supply the gamma-corrected digital video data signal and sustain pulse number information to the digital receiving part 31.

MCM 62 divides digital video data signal (RGB) received from the digital data receiving part 31 by color signal, by frame, and by bit, to store the divided digital video data signal in a frame memory mounted on the MCM 62 and to synchronize with each sub-field, read out data signal mapped in a corresponding sub-field and supply the read data signal to the first buffer 34. For this purpose, a plurality of system control chips each having a control circuit for controlling a PDP, and a plurality of memories for dividing and storing the digital video data signal by color signal, by frame and by bit are mounted on the MCM. The plurality of frame memories can be implemented by SRAMs, DRAMs or the like.

At this time, the plurality of system control chips and the plurality of memories are mounted on a single package during their fabrication process. Also, the MCM package is mounted on a PCB of the control board 13. Here, the MCM package is preferably formed in a ball grid array (BGA) type.

The MCM packages are classified into MCM-L, MCM-D and MCM-C according to the kinds of used substrates. MCM-L uses FR-4 that is a kind of glass epoxy used in a general PCB, as the substrate material. This substrate has an advantage of a low price but also has disadvantages of a low mounting density and a bad heat radiation characteristic. MCM-D uses silicon wafer or ceramic as the substrate material. Since this substrate has a high wiring density and a superior heat radiation characteristic, it provides a useful advantage for the process of a high performance signal. MCM-C is a type having an intermediate characteristic of the aforementioned MCM-L and MCM-D, and uses ceramic as the substrate material. Since this substrate uses ceramic as the substrate material, it has a superior heat radiation characteristic. The control board of the PDP driving apparatus according to an embodiment of the present invention employs the MCM-C type.

Accordingly, the control signal generated from such a multi-chip module is transmitted to each driving part via the PCB of the control board.

The first buffer 34 divides the data signal received from the MCM 62 into first and second data signals and supplies the divided first and second data signals to the second buffer 25 and the third buffer 36.

The second buffer 35 is connected between the first buffer 34 and the first address driving part 18A to buffer the first data signal received from the first buffer and supply the buffered first data signal to the first address driving part 18A.

The third buffer 36 is connected between the first buffer 34 and the second address driving part 18B to buffer the second data signal received from the first buffer 34 and supply the buffered second data signal to the second address driving part 18B.

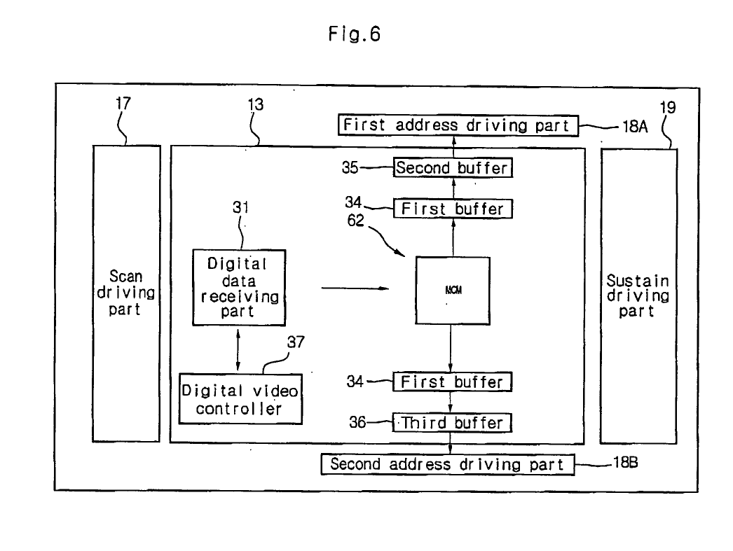

FIG. 6 is a view in which the control board of FIG. 5 is applied to a driving apparatus of a plasma display panel.

The MCM mounted on the control board 13 according to the present invention is fabricated such that a plurality of system control chips and a plurality of frame memories are mounted on a single package. That is, in the conventional art, the system control chip and the frame memory are separately packaged and mounted on the control board, while in the present invention, the plurality of system control chips and frame memories are fabricated on the MCM 62 as one package. Accordingly, the control board of the PDP according to a preferred embodiment of the present invention can be reduced to half in its size compared with the conventional control board.

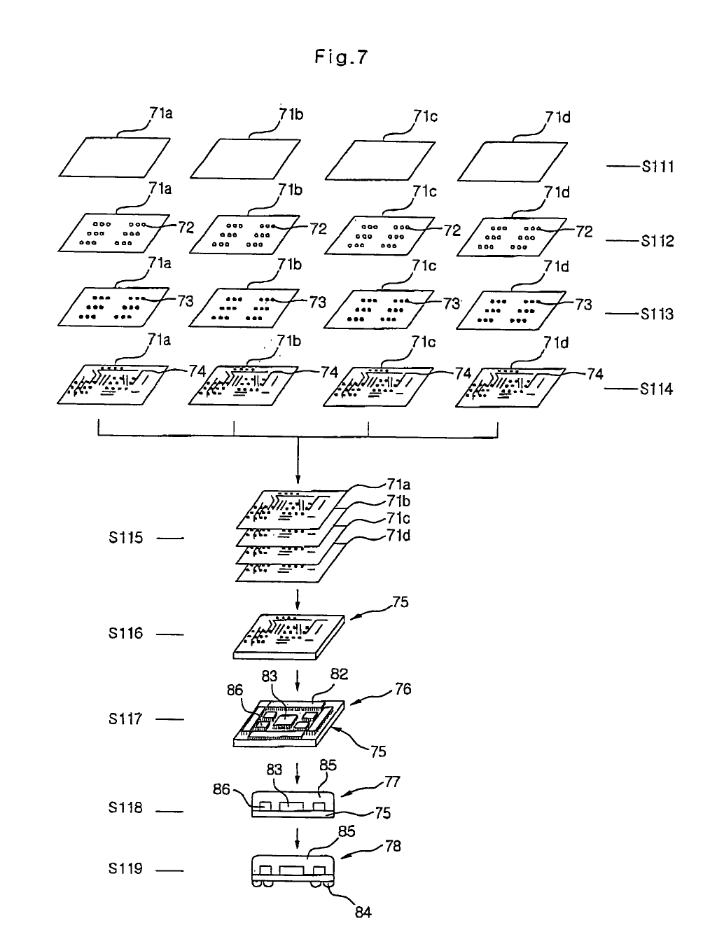

Hereinafter, with reference to FIG. 7, a method for fabricating a multi-chip module package will be described.

FIG. 7 illustrates a fabrication process of a multi-chip module package mounted on the control board of FIG.

Referring to FIG. 7, first, a green tape wound on a roller is cut in a predetermined size so as to provide a plurality of green tapes (S111). The provided green tapes 71a to 71d are processed in the form of a substrate type on which a circuit pattern 74 can be formed. Here, the green tape is fabricated using the following steps of: drying a slurry obtained from a mixture of a glass powder with a binding agent for maintaining a viscosity of the glass powder, a plastic agent for providing a flexibility so as to prevent a hardening, a solvent for dissolving the binding agent and the plastic agent and other small quantity of additives; and processing the slurry to have a predetermined thickness in a tape casting manner for its winding on the roller. The green tape used in the control board of the PDP according to a preferred embodiment of the present invention has a characteristic of a low temperature co-firing in a Low Temperature Cofired Ceramic (LTCC) type. In the present invention, four sheets of green tapes are provided, but according to the circuit configuration of the MCM, more than four sheets of green tapes can be also used.

At this time, in each of the green tapes 71a to 71d, a plurality of via holes 72 are formed using a mechanical punching way (S112).

Next, after a conductive paste 73 is filled in the via hole 72 of the green tapes 71a to 71d, the filled conductive paste is dried for a predetermined time (S113). At this time, as the conductive paste filled in the via hole 72, a conductive material such as silver (Ag) can be used. Such conductive material allows the circuit patterns 74 formed on each of the green tapes 71a to 71d to be respectively connected with one another in a subsequent process.

As mentioned above, if the conductive paste 73 is filled, each of the green tapes 71a to 71d has the circuit pattern 74 respectively formed thereon using a screen print way, etc. (S114). At this time, as a circuit pattern-forming material, silver (Ag) can be used like the conductive paste.

The green tapes 71a to 71d having the electrode pattern formed thereon are respectively sequentially arranged such that they correspond to the configuration of the circuit pattern formed on each of the green tapes (S115).

If, in the step (S115), each of the green tapes 71a to 71d is arranged, the green tapes 71a to 71d are laminated and combined with one another using a laminating technique. The laminating technique represents a process in which the laminated green tapes are pressed by applying a predetermined pressure thereto using a press.

After that, the combined green tapes 71a to 71d are co-fired by a predetermined heat. At this time, the co-fired combined green tapes 71a to 71d serve as a ceramic substrate, and such laminated ceramic substrates become a circuit package 75 having a plurality of circuit layers.

On a front surface of the circuit package 75, a system control chip 83, a frame memory 86, and a passive device such as a resistor (R), an inductor (L), a capacitor (C), etc., a surface mounting device 82 such as a transistor, etc. are mounted, and in order to correspond to a signal line of each of the mounting devices, a wire-bonding is performed using a material such as silver (Ag) (S117).

On the front surface of the package formed in the step (S117), a coating material is coated serving as a passivation layer (S118). At this time, as the coating material, synthetic resin-based material can be used.

Lastly, solder balls 84 are attached to each of input/output pads positioned on the rear surface of the package 77 manufactured in the step (S118), using a solder ball reflow process (S119).

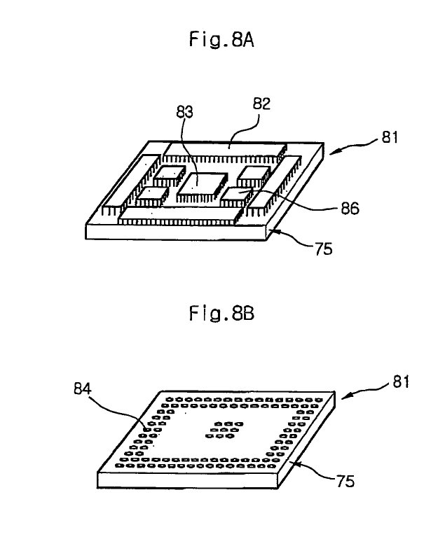

In the MCM package 78 fabricated through the aforementioned process, as shown in FIG. 8, a variety of electronic elements are mounted on a front surface thereof and a solder ball is attached on a rear surface thereof. Also, the fabricated MCM package 78 is mounted on the PCB of the control board.

As aforementioned, the system control chip 83, the frame memory 86 and other electronic elements 82 are mounted on the MCM package 78. The MCM package 78 has a fabrication process similar to that of the BGA (Ball Grid Package), and is fabricated in a size that is the same as that of the ASIC that is a BGA package used in the control board of the conventional PDP. Accordingly, the plurality of system control chip 83, the plurality of frame memories 86 and other several electronic parts are mounted on the conventional BGA package size, thereby reducing the size of the control board to ½ of the size of the conventional control board.

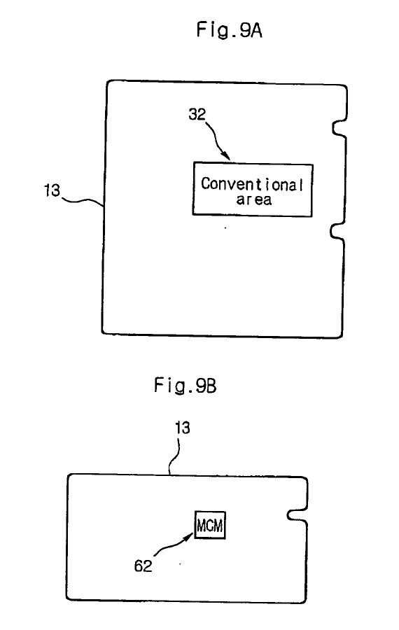

FIGS. 9A and 9B show an inventive control board and a conventional control board respectively.

In the conventional control board of FIG. 9A, there is shown an area 32 when ASIC, frame memories and the like are fabricated in a separate package type and mounted on the PCB of the control board 13. On the other hand, in the inventive control board of FIG. 9B, there is shown an area 62 when ASIC, frame memories and the like are fabricated in a single MCM package and the fabricated MCM package is mounted on the PCB of the control board 13. Comparing the conventional area 32 with the area 62 of the present invention, it is known that the size of the area 62 of the present invention is reduced to ⅛ of the size of the area 32. Thus, as the size of the MCM package is reduced, the size of the control board is also reduced to approximately ½ of the size of the conventional control board.

Accordingly, since I/O signal lines are connected on the MCM package, the wiring area of the I/O signal lines required on the PCB of the conventional control board is not further needed and the number of the I/O signal lines in the package is decreased to a considerable degree.

Also, as in the inventive control board, there is no need of the wiring area of the I/O signal lines required on the PCB of the conventional control board, it is possible to prevent the inductance increase caused between the I/O signal lines, thereby restraining the generation of electromagnetic waves as much as possible.

In addition, as the inductance between the signal lines is decreased, the electrical characteristic of the driving circuit is enhanced.

As described previously, a driving apparatus of the present invention mounts the system control chip and the frame memory on a single package, thereby reducing the size of the control board to ½ of the size of the control board in the conventional PDP.

Also, since the system control chip, the frame memory and the like are mounted on an MCM package and thereby I/O signal lines can be connected within the MCM package, the I/O signal lines do not occupy a wide wiring area unlike the conventional control board and it is also possible to decrease the number of the I/O signal lines to a considerable degree. As a result, inductance between the signal lines is decreased and thus the electrical characteristic of the PDP driving circuit is enhanced.

Further, according to the PDP driving apparatus of the invention, the size of the PCB of the control board is reduced to 50% of the size of the PCB of the conventional control board and the electrical characteristics of the signal lines are enhanced, so that the generation of electromagnetic waves is decreased.

Furthermore, in the inventive PDP driving apparatus, a variety of electronic elements can be mounted on a single MCM package, so that the number of mounted elements is largely decreased and thus the fabrication costs are reduced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A driving apparatus of a plasma display panel (PDP), comprising a multi-chip module in which at least one control chip having a control circuit for controlling the PDP, and at least one memory are mounted on a single package,
wherein the multi-chip module is mounted on a printed circuit board (PCB) of a control board.

2. The driving apparatus according to claim 1, wherein the package is a ball grid type.

3. The driving apparatus according to claim 1, wherein a control signal generated from the multi-chip module is transmitted to each driving unit via the PCB.

4. A driving apparatus of a PDP, comprising:
a control board provided with a multi-chip module in which at least one control chip having a control circuit for controlling the PDP, and at least one memory are mounted on a single package;
a plurality of driving units for generating and applying a driving signal corresponding to a control signal generated from the control board; and
a PDP for displaying an image by a plasma discharge according to the driving signal applied from each of the plurality of driving units.

5. The driving apparatus according to claim 4, wherein the package is a ball grid type.

6. The driving apparatus according to claim 4, wherein the control board is provided with a printed circuit board (PCB) on which at least one package is mounted.

7. The driving apparatus according to claim 4, wherein the control chip is an ASIC type having a control circuit.

8. The driving apparatus according to claim 4, wherein the multi-chip module is mounted on the PCB.

9. A method for fabricating a driving apparatus of a plasma display panel, the method comprising the steps of:
forming holes and circuit patterns in and on a plurality of substrates;
laminating the plurality of substrates to form a single package such that the circuit patterns formed on the respective substrates are electrically connected with each other through the holes;
mounting at least one control chip and at least one memory on the package; and
coating a coating material on a front surface of the package and attaching solder balls on a rear surface of the package to complete a multi-chip module.

10. The method according to claim 9, further comprising the step of filling a conductive material into the holes formed in each of the plurality of substrates.

11. The method according to claim 9, wherein when the plurality of substrates are laminated, the circuit patterns are electrically connected by the holes filled with the conductive material.

12. The method according to claim 9, wherein the solder balls are attached to be in contact with the conductive material filled in the holes formed on the rear surface of the package.
